(19) United States
(12) Patent Application Publication
(10) Pub. No.: US 2015/0279595 A1
(43) Pub. Date: Oct. 1, 2015

(54) LINEAR IMPACT SWITCH FOR DETECTING GENERALLY HORIZONTAL IMPACTS

(71) Applicants: MARK E RALSTIN, BOISE, ID (US); JOHN EDWARD HUMPHREYS, Jr., BOISE, ID (US)

(72) Inventors: MARK E RALSTIN, BOISE, ID (US); JOHN EDWARD HUMPHREYS, Jr., BOISE, ID (US)

(21) Appl. No.: 14/670,369

(22) Filed: Mar. 26, 2015

Related U.S. Application Data
(60) Provisional application No. 61/970,562, filed on Mar. 26, 2014.

(51) Int. Cl. H01H 35/14; G08B 21/18

(52) U.S. Cl. CPC H01H 35/141; G08B 21/18; H01H 2223/058; H01H 2223/044; H01H 2221/008; H01H 2221/056

(57) ABSTRACT

A linear impact switch provides a contact closure, when pressure-activated at any of multiple locations over substantial distances and surface areas. Preferred switch units are positioned with their impact faces in a generally vertical orientation to receive generally horizontal forces. The switch units may be used to trigger an alarm in a falling rock or slide area, wherein the switch units are placed beside a road, path, or other perimeter, for example, on a barrier, fence, retaining wall, or other structure. The switch units may be simple and durable, using a conductive outer (or forward) member and a conductive inner (or rearward) member, whereby the impact/pressure forces the outer/forward member to make contact with the inner/rearward member, thereby closing the switch to send or relay a signal notifying drivers or authorities of the event that caused the signal, even though the event may be in an isolated or seldom-inspected region.

This application claims benefit of Provisional Application Ser. No. 61/970,562, filed Mar. 26, 2014, entitled “Linear Impact Switch”, the entire disclosure of which is incorporated herein by this reference.

### FIELD OF THE INVENTION

The invention relates to a switch that is actuated by an impact or pressure on its surface, wherein the switch may be oriented generally vertically so that an impact that occurs in a generally horizontal direction will activate the switch. The switch may be installed, for example, on a barrier, wall, or fence, so that an object moving generally horizontally against the generally vertical switch will activate the switch. An especially-preferred application is installation of the switch on or near a barrier or guard-rail near a road, path, or equipment, so that an avalanche, falling rock, or mud-slide will fall or roll against the switch to activate the switch to signal that the event has occurred.

### SUMMARY

The invention comprises switch system apparatus, and/or methods of using apparatus, that provide a contact closure, when pressure-activated at any of multiple locations over substantial distances and surface areas. One or more switch units are provided that may extend along a significant distance to signal an event that may happen at any location along said distance, the event comprising or relating to an object impacting/pressing one or more of the switch units to signal the event.

Preferred switch units are positioned with their impact faces in a generally vertical orientation to receive generally horizontal forces. An especially-preferred embodiment and/or method comprises triggering an alarm in a falling rock or slide area, wherein the switch units are placed beside a road, path, fence, retaining wall, or other perimeter. For example, certain embodiments of the invention may be installed on standard 10 ft. long concrete “jersey-barriers” used as a barricade against falling, sliding, or rolling debris, for example, to limit or prevent the debris from entering a roadway. By using certain embodiments of the invented switch system on one or preferably a line of said barriers, travelers, officials, and/or highway agencies may be made aware of the movement of debris against and even over the barrier(s). This way, the travelers may be alerted to slow down and/or the officials/agencies may be alerted that remediation of the situation is needed or that subsequent, additional falling, sliding, or rolling of debris may be imminent.

Instead of providing a single point of contact for activation of the switch, certain embodiments of the invention provide many, and preferably practically limitless, contact points along the length and/or width of each switch unit. Relay technology may be integrated into certain embodiments of the switch system to adapt the system to detect an event at any, or substantially any, locations along long sections of adjacent barriers or other elongated structures, for example, along many feet, yards, or even miles of said barriers/structures. Typically the switch system will be installed along sections of road where falls or slides are known to happen or are anticipated in the future.

The contact closure system of each switch unit comprises multiple, elongated, parallel or generally parallel, electrically conductive components that normally are spaced apart so that they are not in contact, resulting in the switch normally being open. An impact and/or pressure pushes an outer component of said conductive components inward to contact an inner component of said conductive components. Said contact of the inner and outer components closes the switch, hence allowing current to flow to signal the impact/pressure that typically equates to an undesirable or dangerous event.

In certain embodiments, the two elongated, conductive components may comprise an elongated rod, bar, channel, tube, or other member (“rod” hereafter) and an elongated plate, wherein the rod is the inner or “rearward” component and the plate is the outer or “forward” component. Upon impact/pressure on one or more regions of the plate, the plate will move inward or “rearward” to contact the rod, closing the switch. In preferred embodiments, the inward or rearward movement is flexing of the plate or at least a portion of the plate, but other ways and means of moving are envisioned, for example, sliding or pivoting. More than one rod may be provided in various locations inside the switch unit to ensure that the moving/flexing plate will contact one or more rods. One or more plates or plate portions may be provided in a switch unit, but a single continuous plate is preferred for each switch unit, so that sealing against the environment is enhanced, and so that impact/pressure against nearly any region of the single plate will move/flex the plate to an extent that part of the plate contacts the rod(s).

Contact between the conductive components serves as the switch that energizes a relay. The output of the relay circuit (also “relay”) provides the signal of event detection. The electrical resistance of the materials used in the switch will determine the possible length/dimensions of the elongated conductive components, and the distance a switch unit will function using a single relay. Switch units may be manufactured at fixed lengths, for example, several feet long, but multiple switch units may be aligned, for example, end-to-end along a span, and electrically connected by junctions and using multiple relay circuits, in order to extend the distance that the system operates. The longer the span, the more relay circuits may be needed, but, with the switch units wired in parallel, any contact point within any individual switch unit will generate the closure and signal the impact/pressure event. Said signal may be sent wired to a local controller, which may activate a warning beacon or audio alarm near the impact zone, and/or wirelessly using existing cellular or satellite technology to inform those who wish to monitor such events. Thus, the control room of the emergency management personnel may be remote from the event causing the signal.

The distance (or “span”) which is monitored by the switch system for impact/pressure events may correspond approximately to the total length of the multiple switch units. The vertical height range being monitored will correspond approximately to the width of each switch unit. If all the switch units are the same width and are all installed at about the same level above the ground/road, then the vertical height range being monitored will be the same, or substantially the same, all along the span.

In certain embodiments, the conductive plate or other outer conductive component is somewhat flexible and resilient, so that the impact/pressure pushing it inward to close the switch does so without permanently denting, scarring, or closing the switch. This way, after the rock or other cause of the alarm has been removed, the outer conductive component of the switch unit initiating the alarm will return to be at or very near its original position, and hence the switch unit will return to a switch-open condition. The unit would be visually and/or electrically/electronically inspected for the return to the switch-open condition and for damage that might cause an inadvertent/accidental switch-closure and alarm signal. Alternatively, because the preferred switch units are modular in design, for disconnection from each other and easy replacement of individual units, a damaged unit may be easily replaced if there is a question about its condition or future performance.

### BRIEF DESCRIPTION OF THE DRAWINGS

FIG. 1 is a front view of one embodiment of an invented switch unit, wherein wires extending from one end of the unit (top of sheet) are for connection to another switch unit via relay and/or junction apparatus, and wires extending from the other end (bottom of sheet) are for connection to the illustrated controller.

FIG. 2 is a side isometric view of the unit of FIG. 1.

FIG. 3 is a side (edge) view of the unit of FIG. 1, without any wiring extending from either end of the unit.

FIG. 4 is a cross-sectional side view of the unit of FIG. 1, viewed along the line 4-4 in FIG. 1.

FIG. 4a is a detail of the region of the unit surrounded by dashed lines in FIG. 4.

FIG. 5 is a cross-sectional end view of the unit of FIG. 1, viewed along the line 5-5 in FIG. 1.

FIG. 6 is a cross-sectional end view of the unit of FIG. 1, viewed along the line 6-6 in FIG. 4 and also generally along the line 6-6 in FIG. 1.

FIG. 7 is a front view of a portion of a switch system according to one embodiment, with junction and relay apparatus connecting two switch units.

FIG. 8 is a side view of another embodiment of switch system, schematically showing multiple switch units electrically connected via relay and/or junction apparatus, and to a controller, to form a switch system spanning a long distance along a road, path, fence or barrier system.

FIG. 9 is a wiring schematic of two switch units electrically connected together and adapted for connection to additional switch units, to form a switch system spanning a long distance along a road, path, fence or barrier system.

FIG. 10 is a front isometric view of a single switch unit installed on a side of a single barrier, so that the unit is generally vertical on one side of the barrier.

FIG. 11 is a front isometric view of one embodiment of a multiple-unit switch system on a line of barriers, with relay and/or junction equipment between the switch units.

FIG. 12 is an end view of one embodiment of a switch unit/system on a barrier, wherein rock/debris has fallen (or is falling) against the barrier, but has not impacted the switch unit, so that the switch is still open.

FIG. 12a is a detail of the impact region of FIG. 12, wherein the rock/debris has impacted and depressed the front face of the switch unit so that a portion of the front face contacts the inner rod and closes the switch.

FIG. 13 is a front isometric view of another embodiment of a multiple-unit switch system on a line of barriers, including embodiments of relay and/or junction equipment in dashed lines inside the housings of the switch units.

FIG. 14 is a front view of an alternative switch unit with two conductive inner rods extending longitudinally through the inside of the switch unit and spaced from the single conductive cover of the unit, wherein wires extending from one end of the unit (top of sheet) are for connection to another switch unit via relay and/or junction apparatus, and wires extend from the other end (bottom of sheet) for connection to a controller.

FIG. 15 is a front view of one embodiment of a switch unit electrically connected to relay and junction equipment (top of sheet) and having wires extending (bottom of sheet) for connection to another switch, wherein the illustrated switch unit and relay-and-junction apparatus are at the far-end of a switch system opposite a controller.

### DETAILED DESCRIPTION

Referring to the Figures, there are shown several, but not the only, embodiments of the invented switch unit, switch system, and/or unit/system installation and use.

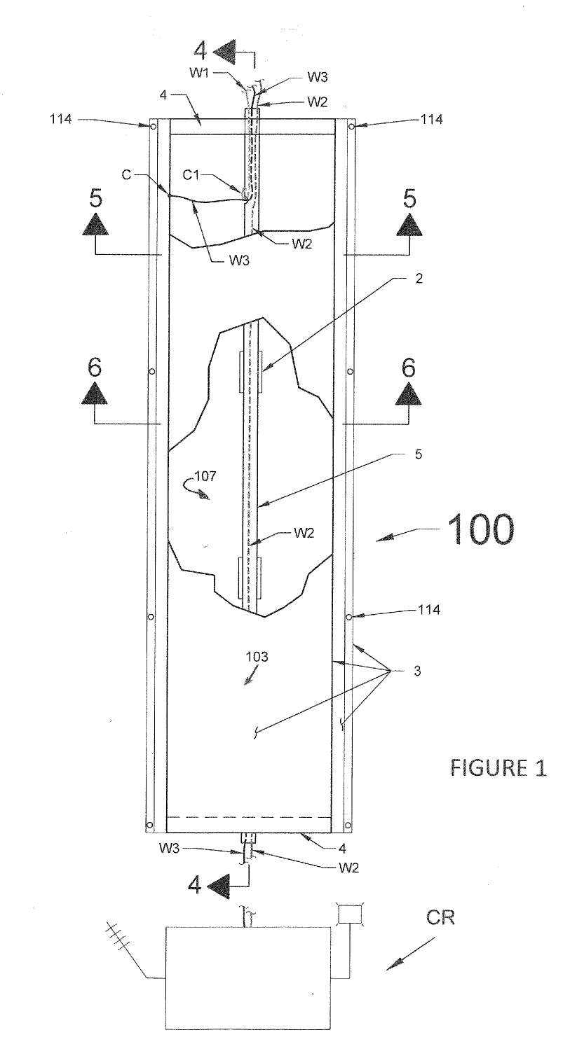

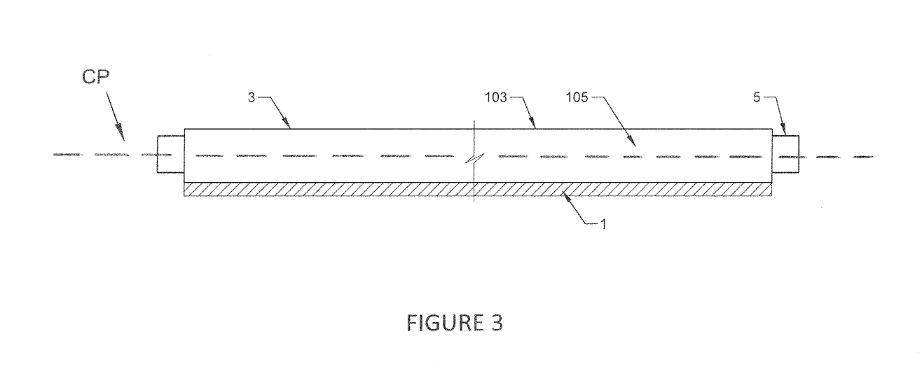

FIGS. 1-6 illustrate one embodiment of a switch unit 100 that may be called a “linear impact switch” due to the switch being elongated and adapted to receive an impact at many places, and preferably substantially all along its length and its width, to close its switch. The switch unit 100 is preferably longer (up and down in FIG. 1) than it is wide (left and right in FIG. 1), and much longer and wider than it is thick (into the paper in FIG. 1).

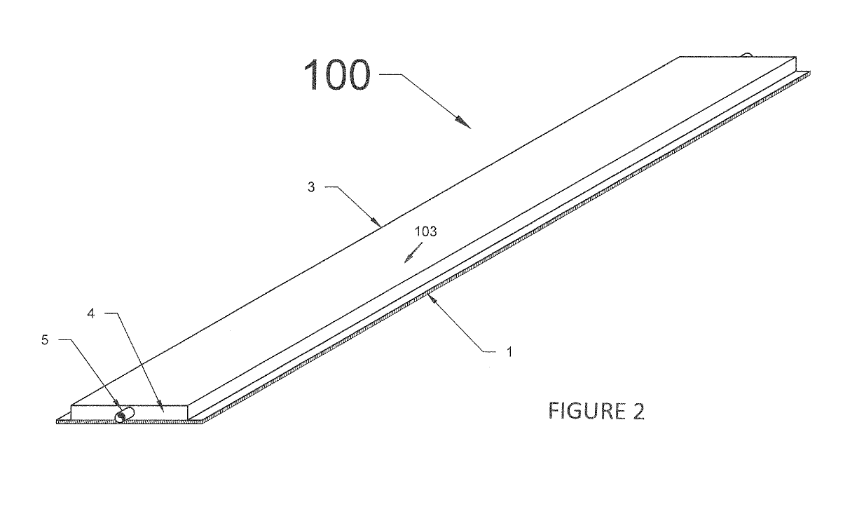

The switch unit (100) may be described as having a housing in which certain conductive element(s) and wiring are held. As best seen in FIGS. 2-6, the housing preferably comprises a rear panel (1) and a front cover (3), and endcaps (4), but may comprise other or additional housing portions in certain embodiments. The switch unit 100 is adapted in dimensions, construction, and materials, so that an impact on its cover (3) will move at least a portion of the cover (3) inward to close the switch mechanism of the unit (100). Preferably, cover (3) comprises front face (103) that moves inward by flexing inward to close the switch mechanism of the unit. The impact may hit/pressure any, or nearly any, part of the front face 103, but the housing or other elements of the unit 100 may be rigid enough near the ends or side edges so that an impact at or very close to the ends or the side edges may not allow the front face 103 to flex sufficiently to close the switch. For example, it is desired that an impact at any point along 80 percent or greater (for example, 80-95 percent) or preferably along 90 percent or greater (for example, 90-95 percent) of the length, will cause flexing of the front face 103 sufficient to close the switch. Also, for example, it is desired than an impact at any point along 80 percent or greater (for example, 80-95 percent) or preferably 90 percent or greater (for example 90-95 percent) of the width, will cause flexing of the front face 103 sufficient to close the switch.

The construction of the switch unit 100 is preferably such that it is much longer than it is wide, as illustrated in FIGS. 2 and 10, 11, and 13, so that a single unit 100 senses an impact/pressure along a significant distance. The width will typically relate/correspond generally to the height range above the ground or road at which, or over which, the user wants to sense the impact/pressure. For example, the unit 100 length may be 2-10 feet long, so it extends along the ground/road about 2-10 feet, while the unit 100 may be 0.5 feet wide and mounted with its bottom edge about 2 feet off the ground, so it will sense an impact/pressure from something that approaches the unit 100 in the range of about 2-2.5 feet above said ground/road. Or, as a further example, a unit 100 that is 2 feet wide and mounted with its bottom edge about 1 foot off the ground will sense an impact/pressure from something that approaches the unit 100 in the range of about 1-3 feet above said ground/road. Or, a unit 100 may be installed so that it is above the ground at any level where an object is expected to approach, for example, a 8 inch-wide unit 100 installed about 3 feet above the ground/road on a guard-rail or fence-rail at the level of the rail.

The rear panel (1) is preferably non-conductive and may be mounted to the barrier, wall, or fence, for example, by concrete fasteners (114) or other fasteners. A conductive rod (5), or other elongated conductive member (also “inner conductive member”), spans the length of the unit and is held in place by non-conductive stand-offs (2), as best seen in FIGS. 1, 4 and 6. The rod has a dual purpose by acting as one of the contacts of the switch of the switch unit (100) as well as a conduit for holding wiring inside the interior passage of the rod (5) along at least part of the length of the switch unit (100). The rod (5) is portrayed in the figures as a hollow cylinder, but rods having other outer and/or inner shapes may be used in certain embodiments.

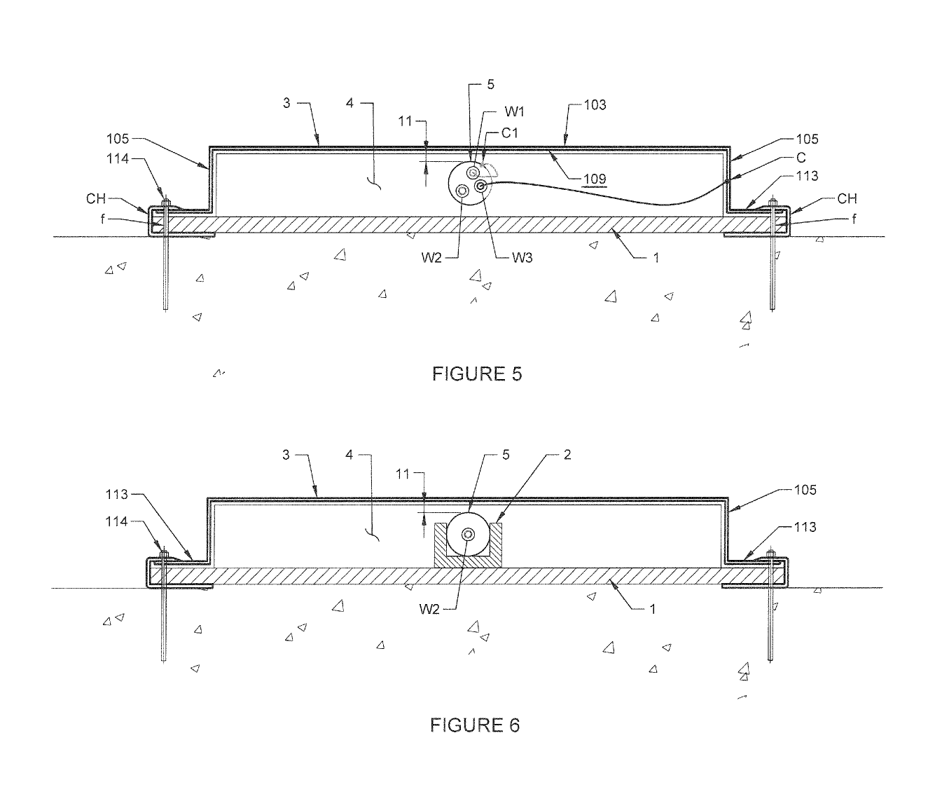

The cover plate (3) is placed on the front of the switch unit (100) and connected to the rear panel (1). Cover plate (3) comprises said front face (103) that is generally parallel to, but distanced from, the rear panel (1) to provide the interior space (107) where the rod (5) and wiring is placed, with a gap (11) between the rear surface (109) of the front face (103) and the front surface (111) of the rod (5). As best seen in FIGS. 5 and 6, in addition to the front face (103), the cover plate 3 also comprises sidewalls (105) that are generally perpendicular to the front face (103), and flanges (113) that are connected to the rear panel (1), for example, by friction-fit metal channels (CH) extending all along the length of the unit (100). Preferably gaskets, weather-stripping, or other moisture-seal means (not shown), are placed between the flanges (113) and the rear panel (1) to prevent moisture intrusion into the interior space (107).

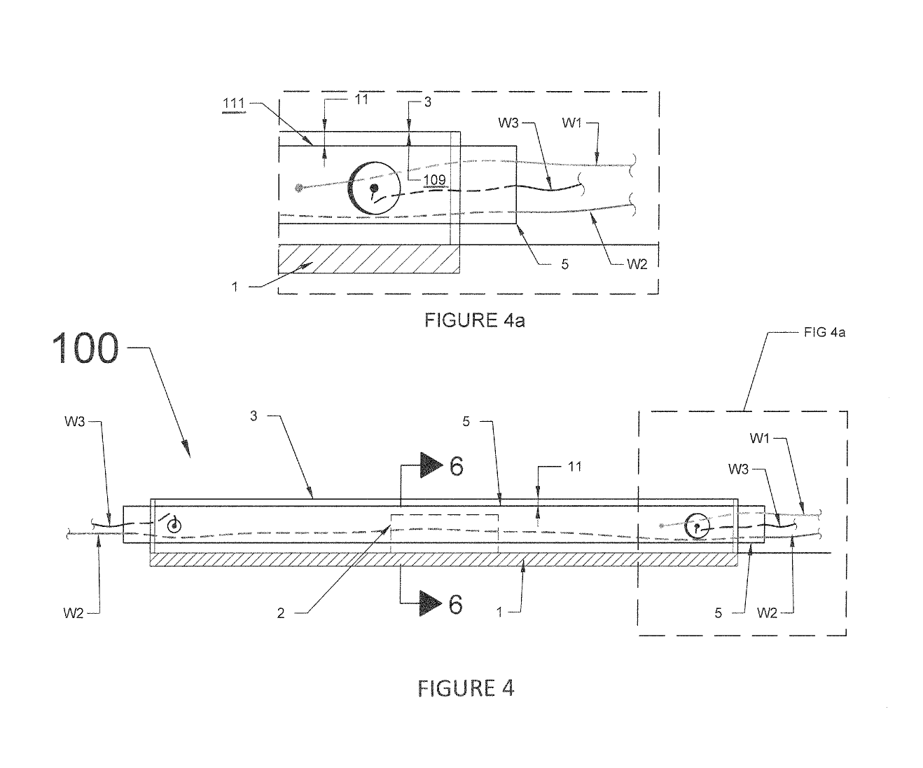

The shape of the preferred cover (3) ensures it remains at a fixed distance from the rod (5) when no impact or pressure is applied by an object against the front face (103). As best seen in FIGS. 4a, 5 and 6, this maintains the air gap (11) (an empty space except that it is filled by air) between the front surface (111) of the rod (5) and the rear surface (109) of the front face (103) preferably over the entire length of the switch unit (100). When an impact event pushes the front face (103) toward the rod (5), the rear surface (109) contacts the rod (5), that is, closing the air gap (11) (reducing it to zero gap) in at least one location along the length of the switch unit (100). Thus, the impact brings the cover (103) into physical and electrical contact with the rod (5), activating the switch. Non-conductive end caps (4) help hold the rod (5) in place, and the preferred rigidity of the rod (5) also keeps the rod (5) in place relative to the end caps (4), and the rear panel (1), so that the rod (5) may be considered immovable or substantially immovable inside the interior space (107).

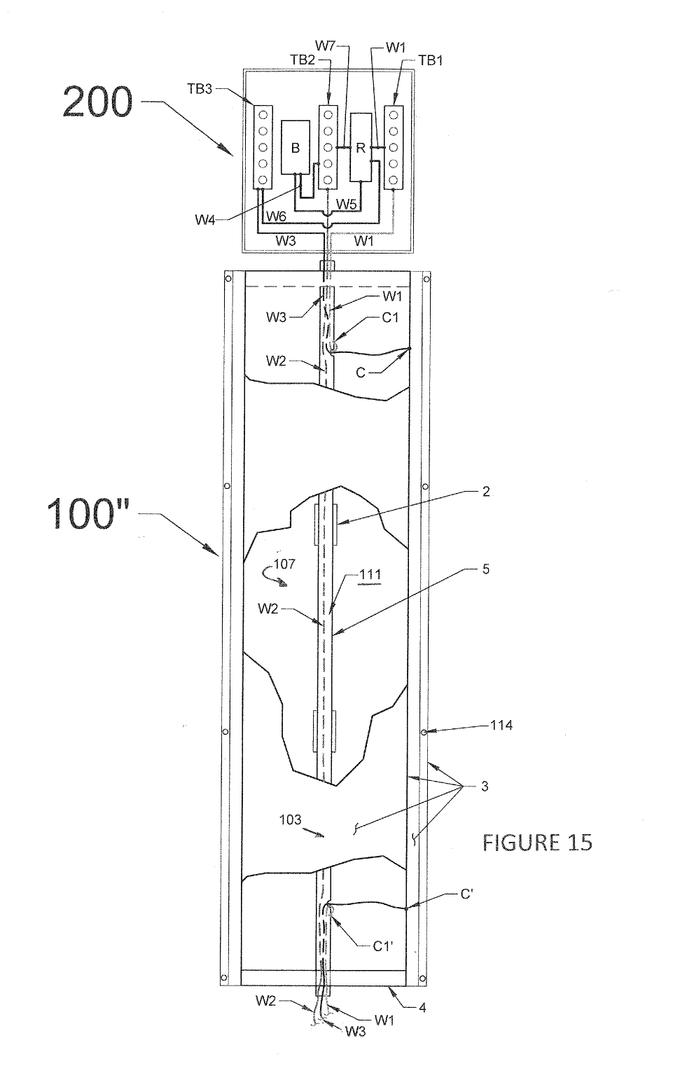

Therefore, rod (5) and cover (3) make up the switch that is used to energize the relay (R), for relaying a signal to a controller (CT, see FIGS. 1, 1, 8, 9, 11, and 13) and transmission of the alarm/notification to a beacon, sign, or control/monitoring room (not shown). As best shown by the top end of FIG. 1 and the bottom end of FIG. 15, and FIGS. 4, 4a, and 5, wires (W1) (via connections C1, C1′ and terminal blocks TB1) electrically connect the rods (5) of the switch units, and wires (W3) (via connections C, C′ and terminal blocks TB3) electrically connect the covers (3) of the switch units. As best seen in FIGS. 1, 7 and 15, wire (W2) (also called “ground/common” wire) which extends all the way through each switch unit by passing through the hollow space of the rod(s) and is connected to the wire (W2) of the adjacent switch units via terminal block (TB2), is connected (via terminal block TB2 and W4) to the negative side of a low-voltage power supply (for example, battery B), and ground to the controller (CR). The positive side of the low-voltage supply (B) is connected by wire (W5) to one end of the coil of the relay (R). The other end of the coil of the relay (R) is electrically connected to the cover (3), for example, via wire (W6), terminal block (TB3), wire (W3), and connection point (C). Therefore, when the cover (3) is impacted with enough force to be pressed against the rod (5), contact is made which energizes the relay (R). The output of the relay (R) is electrically connected to wire (W2) via wire (W7) and terminal block (TB2), providing the feedback necessary to detect the event. It will be understood that the wires described and shown will be electrically-conductive, for example, copper. Conventional battery(ies) B, relays (R), and terminal blocks (TB1, TB2, and TB3), and housing and wiring for these components may be used, and one of average skill in the electrical arts will be able to assembly and the wire the units (100) into a switch system (300) after viewing this disclosure and the drawings. Also, after viewing this disclosure, one of average skill in the electrical and/or control arts will be able to operatively connect the switch system (300) by wire or wireless communication to a light, beacon, alarm, and/or control/monitoring room.

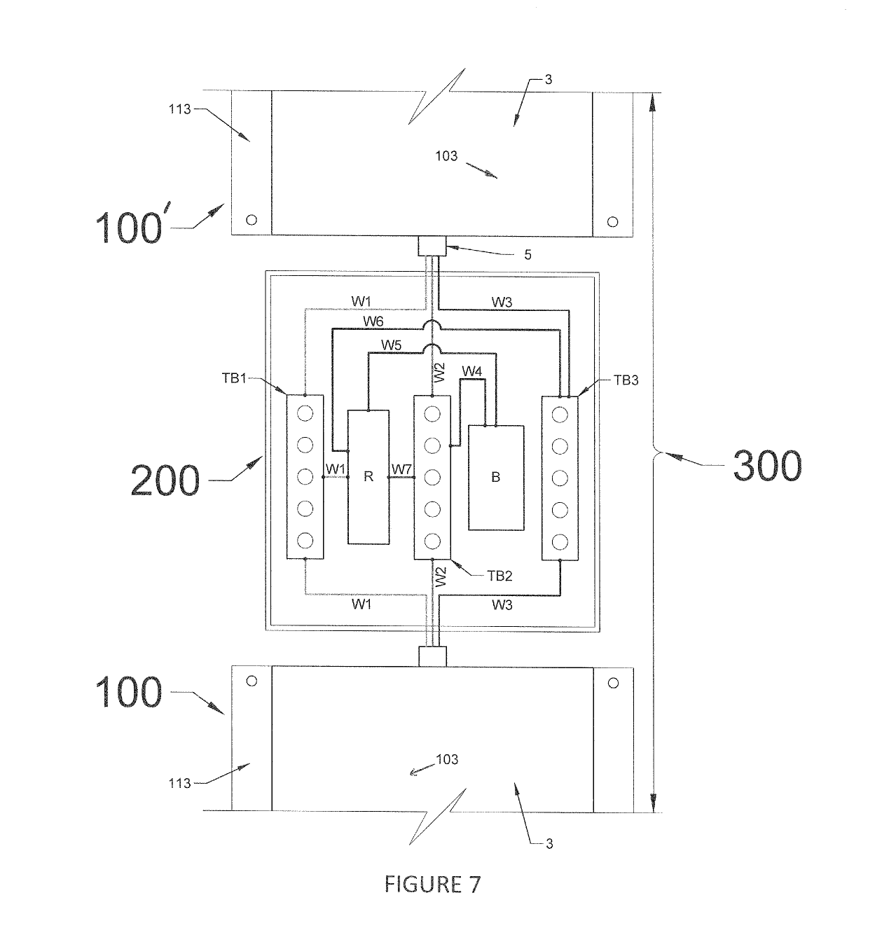

The switch units (100) are preferably manufactured at fixed lengths, and, since electrical resistance in the wires is much lower than in the materials of the rod (5) and cover front face (103), greater distances can be attained with a switch system (300) that comprises multiple switch units (100) and one or more relays (R), rather than just a single switch unit (100). The electrical resistance of the materials used will determine the distance that the system will function using a single relay circuit. As best seen in FIGS. 7-9, 11, 13, and 15, the units (100) can be operatively connected into a system (300) by electric connection of the multiple switch units via relay circuits (200) or by junctions (200′), as will be understood from this description and the drawings. Thus, switch system (300) includes multiple switch units (100) (also “modules”) operatively connected by relays (200), providing the junction function and also the relay function, and also by junctions (200′) that provide junction function but not relay function. The longer the span, the more relays (200) will be integrated.

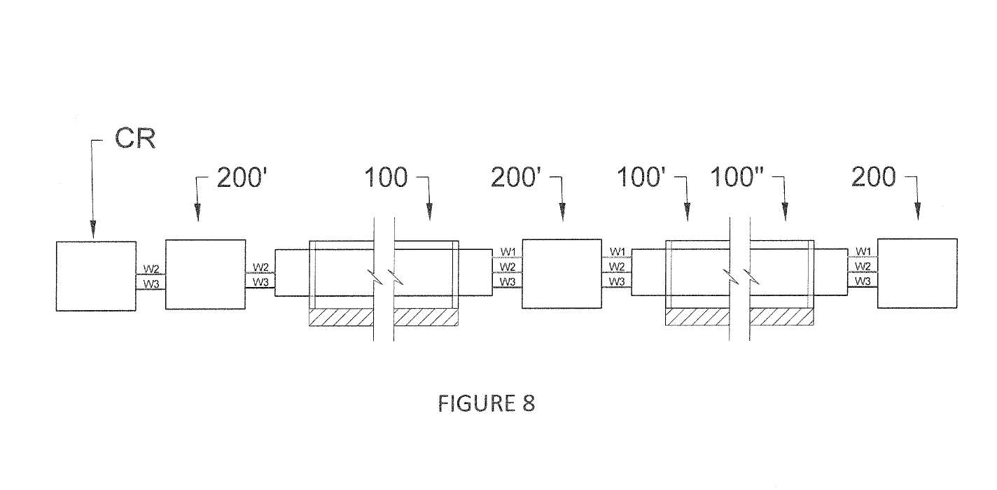

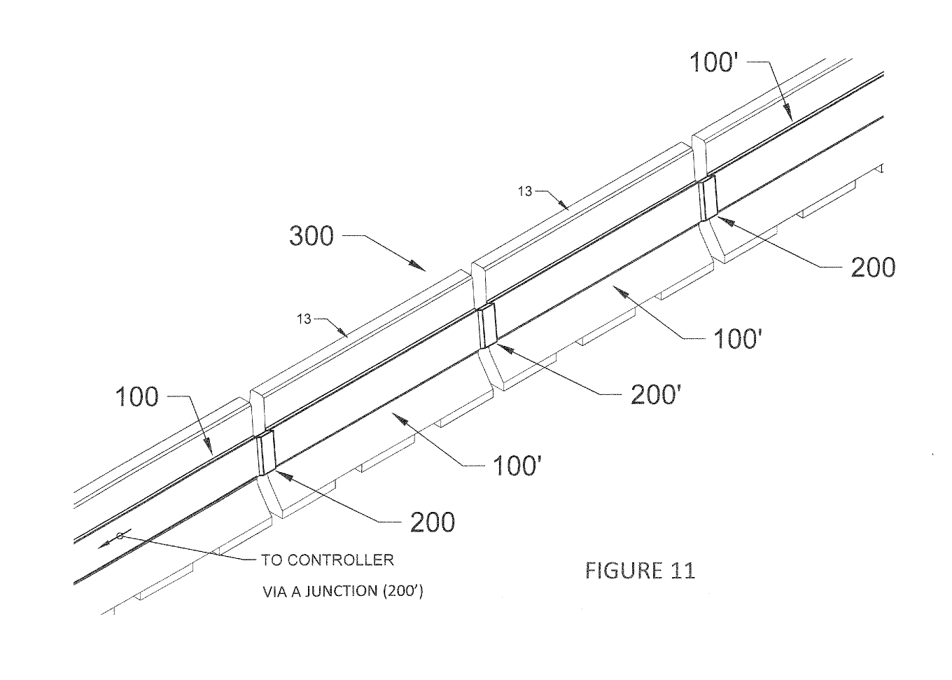

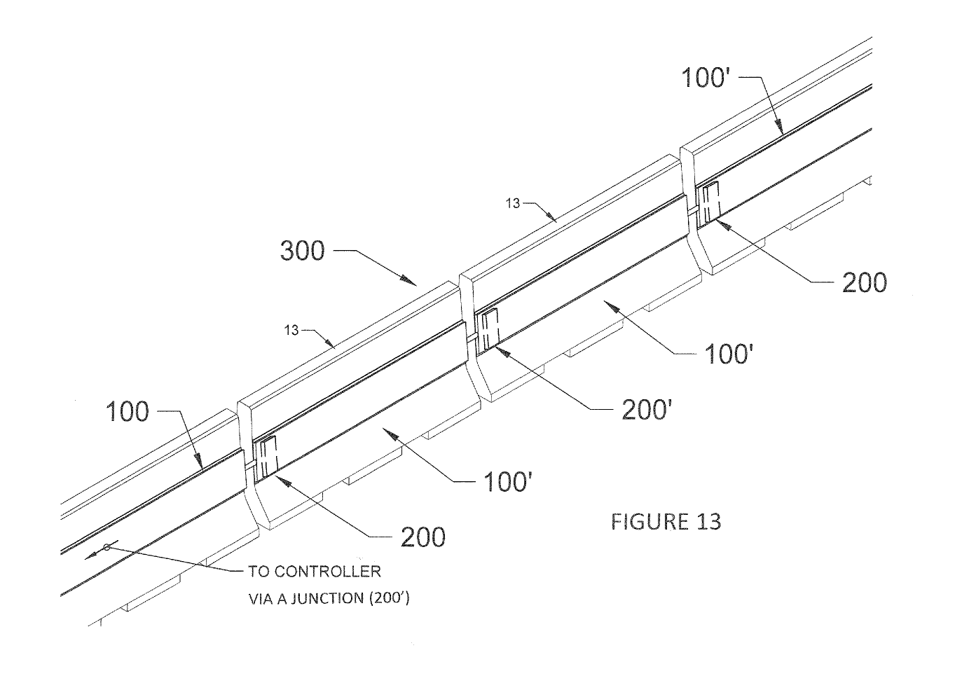

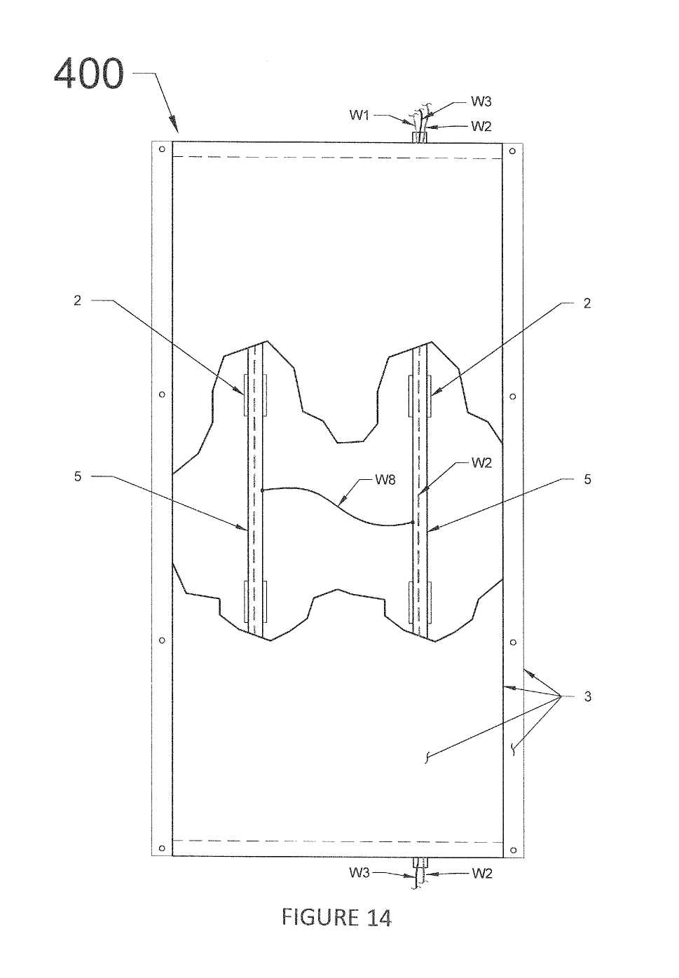

In FIGS. 1, 7, and 8, 9, 11, 13, the call-out number “100” is used to denote the switch unit that is closest to the controller, for example, at the far left of the “string” of switch units in FIGS. 11 and 13, wherein typically wires (W1, W2, and W3) extend from one end to another switch unit 100′ via a relay (200) or junction (200′), but typically only wires (W2) and (W3) extend from the other end of the switch unit 100 to, via a junction (200′) (see FIG. 8), connect to the controller (CR). Call-out number “100 prime” (100′) is used to denote a switch unit anywhere in the middle of the “string”, which connects via relays (200) or junctions (200′) to two other switch units, that is, one at each end of the switch unit 100′ (see FIGS. 7, 8, and 9, 11, and 13). Call-out number “100 double prime” (100″) is used to denote the switch unit at the far-end of the “string” of switch units, that is, at the end opposite from the controller CR, as shown in FIG. 15. It may be noted that the relay (200) in FIG. 15 is at the end of the switch system and, while it comprises relay equipment and terminal blocks for connection of wires, it does not comprise wiring to another switch unit. In this description and the drawings, the call-out “100” is used generally, that is, to represent any switch unit in a system (300), unless the context of the writing or drawings is pointing out a particular position in the “string” of units.

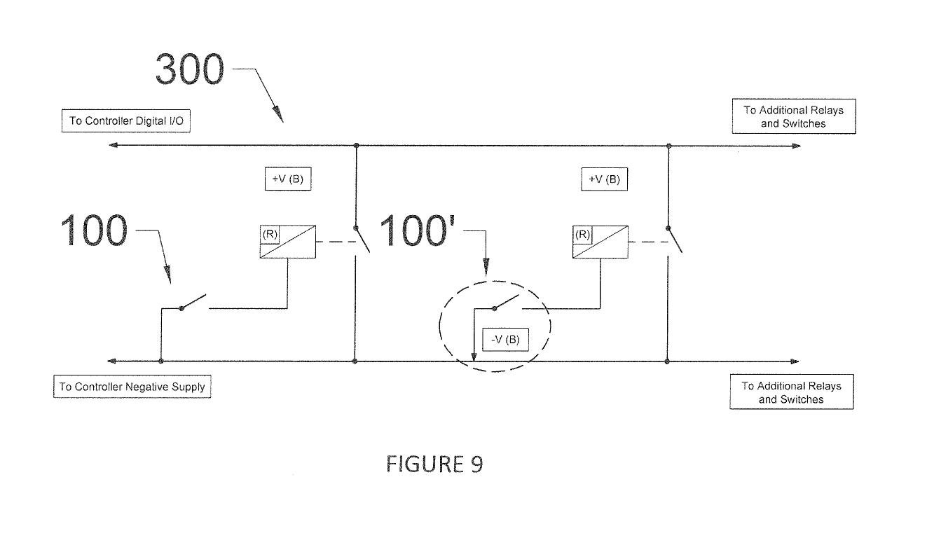

In certain embodiments, multiple of the switch units (100) are close enough to each other, and/or the impacting object is so large, that a single event/object (a single rock, a single mud-slide, a single tree, etc), will impact multiple of the units (100). In certain embodiments, a single event/object will impact only one of the units (100). Since the units (100) are wired in parallel, as shown in FIG. 9, a contact point within any individual unit (100) will generate the switch closure, and, hence, the alarm signal.

The length of each switch unit (100) is preferably parallel to the length of the barrier or other object onto which the unit is mounted and which extends along a horizontal distance. Each unit (100) may be considered generally flat and generally planar, for example called a “switch plate”, due to its much greater length and width compared to its thickness. For example, the front of the unit (100) is substantially a plate and the rear is substantially a plate, and the thickness in-between (the sides and the ends) are small in comparison to these front and rear plates. For example, in certain embodiments, the front and rear plates are each at least 8, at least 24, at least 40, or at least 120 times greater in length than the thickness of the unit (100) and preferably at least 2, at least 3, at least 6, or at least 10 times greater in width than the thickness of the unit (100). Thus, the switch unit may be said to have a central plane (CP, into the paper, in FIG. 2) through the unit (100) that is generally or exactly parallel to both of the front face and the rear plate, wherein the orientation of the central plane is representative of the orientation of the front face and the unit as a whole. In certain embodiments, the unit (100) is mounted and used in a generally vertical position, that is, wherein the central plane of the unit, and the front face of the unit is generally vertical. “Generally vertical”, in this mounting and use context, means nearer vertical than horizontal, specifically within less than 45 degrees of vertical. Thus, preferably at least the front face (103), and preferably both the front face and the central plane (CP), are within 44 degrees or less of vertical, in other words exactly vertical or slanted rearward away from the likely impact source up to and including 44 degrees (more preferably up to and including 40 degrees, 30 degrees, 20 degrees or 10 degrees) or slanted forward toward the likely impact source up to and including 44 degrees (more preferably up to and including 40 degrees, 30 degrees, 20 degrees or 10 degrees).

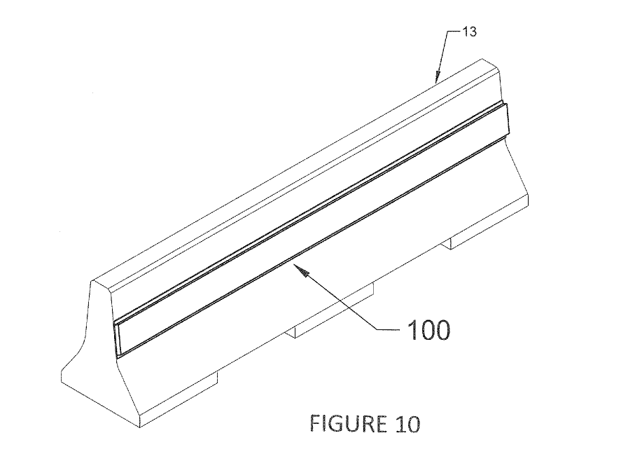

Certain, but not the only, examples of installation are shown in FIG. 10-13. One or more switch units (100), and preferably an entire system (300) comprising multiple units (100) with multiple relays (200) and typically also multiple junctions (200′), are provided on conventional road-side barrier(s) 13. As shown in FIG. 11, the relay (200) and junction (200′) apparatus may be provided in separate, water-proof housings between the switch units, for example, wherein the relay (200) and junctions (200′) alternate and the final (farthest from the controller) apparatus is a relay (200) as shown in FIG. 15. Alternatively, as shown in FIG. 13 the relay (200) and junction (200′) apparatus (in dashed lines) may be provided inside the switch units, that is, inside the housing in the interior space (107) of each switch unit, for example, wherein the relay (200) and junctions (200′) are provided in alternate units and the final (farthest from the controller) relay (200) apparatus would be housed inside the final unit 100″ rather than being in a separate housing as it is shown in FIG. 15. Therefore, for example, the final switch unit 100″ might have both a junction (200′) in the interior space 107 at one end (bottom end of FIG. 15, to connect with another switch unit 100′) and a relay (200) in the interior space 107 at the other, outer end (top of FIG. 15).

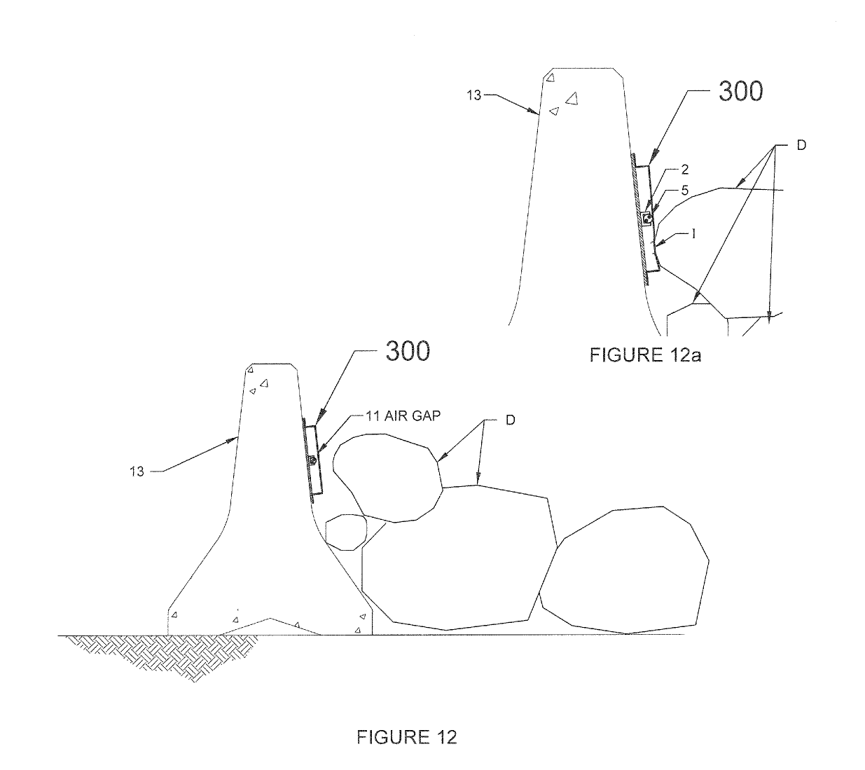

System installations, such as shown in FIGS. 10-13, may be particularly beneficial for avalanche, falling rock, and mud-slide warning systems, for example. In such installations, the portion of the side of the barrier 13 onto which the unit(s) (100) is/are mounted slants rearward about 5 degrees from vertical, and the front face of the unit, and also its central plane (CP) are orientated at about that same orientation (that is, slanted rearward about 5 degrees). In other words, the unit (100) slants slightly rearward from vertical (rearward being away from the impact source, or the rocks) but is still generally vertical and is facing the likely location of the fall/slide, and so will be impacted by rocks or other debris (D) that falls or rolls to the barrier as long as the rock/debris reaches as high as some part of the unit (100). See the detail in FIG. 12a, wherein the rock/debris impacts/presses against only a lower region of the unit (100), and not directly in front of the rod (5), but the pressure on the front face depresses/flexes a substantial portion of the front face to an extent that a higher-up portion of the front face also flexes inward to contact the rod (5) in order to close the switch. Thus, the rock/debris (D) closes at least one switch in the switch unit (300), but may impact and close the switches of multiple switch units (100).

Preferably, the materials of cover (3) are selected so that wherever the impact location (I) is on the cover (3) of a switch unit (100), the switch will close by closing gap (11), to signal the presence of the rock/debris (D). The materials and construction of the switch unit may be selected for a particular range of impacts, that is, to close the gap (11) upon impact by a particular object weight to match the expected problematic object movement. For example, the switch unit may be designed to move to a switch-closed position upon a pressure of greater than 50 pounds per square inch, or greater than 100 pounds per square inch, or greater than 200 pounds per square inch.

The signal, from one or more switches of the system (300) closing, may be sent wired to a local controller (CR) which may activate a warning beacon or audio alarm near the impact zone, or wirelessly using existing cellular or satellite technology to inform those who wish to monitor such events. Thus, the control room of the emergency management personnel may be remote from the event causing the signal. Adaptations may be made in the system (300), and/or its controller/control room, to activate the warning beacon or audio alarm or wireless signal when the switch closure initially happens, even if the switch closure is of short duration. Alternatively, adaptations may be made in the system (300), and/or its controller/control room, to activate the warning beacon or audio alarm or wireless signal only when the switch closure continues for a certain amount of time, for example, for more than 5 seconds, more than 10 seconds, more than 30 seconds, or more than 1 minute. This may adapt the system to account for “false alarms”, for example, caused by animals, pranksters, or other temporary or accidental circumstances. Alternatively, the materials of the cover (3) may be chosen so that a substantial force, such as a rock, tree, or mud slide, is required to close the switch, but an animal or other moderate force will not close the switch.

In certain embodiments, the air gap (11) when “open” (for example, no debris against and no flexing of the cover (3)) is approximately 3/16 to 5/16 inches. Or, for other embodiments and/or other materials of construction, the open gap is in the range of 1/16-1 inch, 1/16 inch to 2 inches. In certain embodiments, the dimensions of each switch unit (100) are in the ranges of 24 to 118 inches long, 6 to 10 inches wide, and 1 to 3 inches thick, for example. Or, for other embodiments and/or other materials of construction, the dimensions of each switch unit are in the ranges of 24 to 140 inches long, 6 to 36 inches wide, and 1 to 5 inches thick, for example. Other dimensions may be used in certain switches for certain applications.

If more vertical area is desired to be monitored, switch units may be provided that are wider, so they extend a greater vertical distance. For example, units may be provided that have more than one inner conductive components. For example, unit 400 in FIG. 13 has two conducting rods that are spaced apart across the width of the unit and that are electrically connected by wire (W8). However, by doubling the conductive material in the switch, the distance one relay circuit will cover is reduced by half. Dimensions for a multiple-rod unit, such as the two-rod (5) unit (400), may be, for example, 24 to 120 inches long, 14 to 20 inches wide, and 1 to 3 inches thick.

The materials used for the cover (3) may be galvanized sheet metal, and the materials used for the rod (5) may be galvanized steel, for example, or other durable and conductive materials. In certain embodiments, the conductive plate or other outer conductive component is at least somewhat flexible and resilient, so that the impact/pressure pushing it inward to close the switch does so without permanently denting, scarring, or closing the switch. This way, after the rock or other cause of the alarm has been removed, the cover of the switch unit initiating the alarm would return to its original, switch-open condition, by resiliently moving away from the rod (5) or other inner conductive component(s). Thus, the cover (3) preferably is made/formed of a material and/or thickness that allows the cover front face (103) to flex inward upon impact to be concave, and then (when the debris/object is removed) to resiliently return to its normal outward position, for example, as a planar plate generally or exactly parallel to the rear panel, as explained elsewhere in this document.

After clearing of the impacting objects, the unit would be visually and/or electrically/electronically inspected for the return to the switch-open condition and for damage that might cause a continued, inadvertent, or accidental switch-closure and alarm signal. Alternatively, because the preferred switch units are modular in design, for disconnection from each other and easy replacement of individual units, a damaged unit may be easily replaced if there is a question about its condition or future performance.

Certain embodiments may comprise, consist essentially of, or consist of the following elements:
a linear switch system for signaling the impact of an object against the system, the switch system comprising at least one switch unit comprising (or consisting essentially of, or consisting of):
   a non-conductive rear panel;
   a conductive front cover that is generally parallel to the rear panel and spaced from the rear panel to provide an interior space between the front cover and the rear panel;
   an elongated conductive inner member secured inside the interior space parallel to, but spaced from, the front cover when the switch unit is in a switch-closed position;
   wherein the switch unit is placed in a generally vertical position, and the front cover is sufficiently flexible so that, upon impact from an object moving in a generally horizontal direction, at least a portion of the front cover will move horizontally inward to contact the conductive inner member to be in a switch-closed position;
   wherein the front cover and inner member are wired to produce, when the unit is in the switch-closed position, a signal to an alarm or control station indicating that the impact has occurred. In some embodiments, a relay may be added and electrically connected to said front cover and said inner member to relay the signal to said alarm or control station. In certain embodiments, the front cover may be a plate with sidewalls protruding rearward for connection (by flanges, brackets, gaskets, or other fastening structure) to the rear panel or other rear members. The front cover may be elongated and the inner member may be an elongated tubular member extending along the entire or substantially the entire length of the front cover. The rear panel may be planar but may be other shapes in certain embodiments.

In certain embodiments, the switch unit may consist essentially or, or consist of, the rear panel, the inner member mounted inside the interior space in the unit, the front cover, endcaps or endplates or adaptations in the front cover to close and waterproof the ends, and wiring and circuitry to accomplish the signaling and/or relaying of the signal upon the switch closing. The interior space between the rear panel, front cover, and the endcaps, may be empty except for said inner member (one or more), mounting means for the inner member(s), wiring and air/gasses. Certain embodiments of the switch system may comprise at least four switch units, at least ten switch units, at least 20 switch units, at least 50 switch units, in each case, with sufficient junction and relay apparatus as needed for effective transmission of the signal(s). For example, certain embodiments provide junctions/terminals for wiring between all the switch units, and, additionally, relay circuitry for every two switch units.

Certain embodiments are methods of using linear impact switches and/or systems, according to any of the disclosure in this document or the figures. Certain methods comprise signaling an event along a road wherein the method comprises (or consists essentially of, or consists of):
providing a road-side barrier having a generally vertical side;
providing a switch system comprising a switch unit comprising:
   a rear panel mounted to said barrier;
   a conductive front face that is spaced from the rear panel to provide an interior space between the front face and the rear panel;
   an elongated conductive inner member secured inside the interior space parallel to, but spaced from, the front cover when the switch unit is in a switch-closed position; and
   wherein at least a portion of the front cover is moveable rearward relative to the inner member, and the switch unit is wired so that, when said at least a portion of the front cover is pushed inward to be in a switch-closed position contacting the conductive inner member, an electrical signal is produced; and
the method further comprising:
   mounting the switch unit on the barrier so that the front cover is generally vertical so that, upon an object moving in a generally horizontal direction and impacting the generally vertical front cover, the front cover will flex inward to the switch-closed position;
   and sending said electrical signal to an alarm or control station to communicate that the impact has occurred. At least a portion of the front cover may be moveable rearward relative to the inner member by flexing toward the inner member. Said at least a portion of the front cover may in some embodiments resiliently return to the switch-open position when the object impacting the front cover is removed. Alternatively, substantially all or all of the front cover may be moveable rearward toward the conductive inner member, to close the switch. And, substantially all or all of the front cover may be moveable forward away from conductive inner member, to open the switch again after the impacting object is removed, for example. The rearward movement and the forward movement may be flexibility and resilience in some embodiments. The method may also include providing multiple of switch units and multiple relay circuits electrically connected to the conductive front cover and inner member to relay the electrical signal to an alarm or control station.

Although this disclosed technology has been described above with reference to particular means, materials, and embodiments, it is to be understood that the disclosed technology is not limited to these disclosed particulars, but extends instead to all equivalents within the scope of the following claims.

1. A linear switch system for an impact event such as an impact from an object from an avalanche, rock-fall, or mud-slide, the system comprising at least one switch unit mounted to a generally vertical surface of a road-side barrier having a horizontal length, the switch unit comprising:
elongated, conductive front and rear members extending parallel to the horizontal length to the barrier, the conductive front member facing out away from the barrier and spaced from the conductive rear member in a switch-open position;
wherein at least a portion of the conductive front member is moveable rearward relative to the conductive rear member so that the impact of the object from avalanche, rock-fall or mud-slide pushes said at least a portion of the front member rearward to contact the conductive rear member in a switch-closed position; and
wherein the switch system further comprises electrical circuitry that produces an electric signal when the switch unit is in the switch-closed position for communicating that the impact event has occurred.

2. The linear switch system as in claim 1, wherein said at least a portion of the front member is moveable rearward relative to the conductive rear member by flexing toward the rear member.

3. The linear switch system as in claim 2, wherein said at least a portion of the conductive front member resiliently returns to the switch-open position when the object impacting the front member is removed.

4. The linear switch system as in claim 1, comprising multiple of the switch units and multiple relay circuits a relay electrically connected to the conductive front and rear members to relay the electrical signal to an alarm or control station.

5. The linear switch system as in claim 4, comprising at least four of said switch units and at least two of said relay circuits.

6. The linear switch system as in claim 4, comprising at least ten of said switch units and at least five of said relay circuits.

7. A linear switch system for signaling the impact of an object against the system, the switch system comprising at least one switch unit comprising:
a non-conductive rear panel;
a conductive front cover that is generally parallel to the rear panel and spaced from the rear panel to provide an interior space between the front cover and the rear panel;
an elongated conductive inner member secured inside the interior space parallel to, but spaced from, the front cover when the switch unit is in a switch-closed position;
wherein the switch unit is placed in a generally vertical position, and the front cover is sufficiently flexible so that, upon impact from an object moving in a generally horizontal direction, at least a portion of the front cover will move horizontally inward to contact the conductive inner member to be in a switch-closed position;
wherein the front cover and inner member are wired to produce, when the unit is in the switch-closed position, a signal to an alarm or control station indicating that the impact has occurred.

8. The linear switch system of claim 7, further comprising a relay electrically connected to said front cover and said inner member that relays the signal to said alarm or control station.

9. The linear switch system as in claim 7, wherein the front cover is elongated and has a length, and the inner member is an elongated tubular member extending along the entire or substantially the entire length of the front cover.

10. The linear switch system as in claim 7, wherein the front cover comprises an elongated plate, and sidewalls protruding rearward from the plate and connected to the rear panel, wherein the switch unit comprises weather-proofing material between the rear panel and the sidewalls to seal the rear panel to the front cover.

11. The linear switch system as in claim 7 comprising multiple of said switch units wired in parallel so that impact on the front cover of any one of the switch units signals the alarm or control station.

12. The linear switch system as in claim 7 comprising multiple of said switch units, and comprising wire-junction apparatus between said switch units.

13. The linear switch system as in claim 11, further comprising relay circuitry between at least some of said multiple switch units.

14. The linear switch system as in claim 7, wherein said rear panel is mounted on a generally vertical barrier, wall, or fence, so that the front cover is generally vertical.

15. The linear switch system as in claim 7, wherein said front cover is within 44 degrees of exactly vertical.

16. The linear switch system as in claim 7, wherein said front cover is within 20 degrees of exactly vertical.

17. A method of signaling an event along a road, the method comprising:
providing a road-side barrier having a generally vertical side;
providing a switch system comprising a switch unit comprising:
a rear panel mounted to said barrier;
a conductive front face that is spaced from the rear panel to provide an interior space between the front face and the rear panel;
an elongated conductive inner member secured inside the interior space parallel to, but spaced from, the front cover when the switch unit is in a switch-closed position; and
wherein at least a portion of the front cover is moveable rearward relative to the inner member, and the switch unit is wired so that, when said at least a portion of the front cover is pushed inward to be in a switch-closed position contacting the conductive inner member, an electrical signal is produced; and
the method further comprising:
mounting the switch unit on the barrier so that the front cover is generally vertical so that, upon an object moving in a generally horizontal direction and impacting the generally vertical front cover, the front cover will flex inward to the switch-closed position;
and sending said electrical signal to an alarm or control station to communicate that the impact has occurred.

18. The method as in claim 17, wherein said at least a portion of the front cover is moveable rearward relative to the inner member by flexing toward the inner member.

19. The method as in claim 18, wherein said at least a portion of the front cover resiliently returns to the switch-open position when the object impacting the front cover is removed.

20. The method as in claim 17, comprising providing multiple of switch units and multiple relay circuits electrically connected to the conductive front cover and inner member to relay the electrical signal to an alarm or control station.
